(19) United States
(12) Patent Application Publication
(10) Pub. No.: US 2026/0261364 A1
(43) Pub. Date: Sep. 3, 2026

(54) GROUP-BASED LOW-OVERHEAD RETRANSMISSION SYSTEM FOR LOSSY RDMA NETWORK

(71) Applicant: CHINA UNIVERSITY OF GEOSCIENCES (WUHAN), Wuhan (CN)

(72) Inventors: Deze ZENG, Wuhan (CN); Puyu ZHAO, Wuhan (CN); Shugui WEI, Wuhan (CN); Zhexiong LI, Wuhan (CN); Yuepeng LI, Wuhan (CN)

(73) Assignee: CHINA UNIVERSITY OF GEOSCIENCES (WUHAN), Wuhan (CN)

(21) Appl. No.: 19/653,702

(22) Filed: Apr. 21, 2026

(30) Foreign Application Priority Data
Dec. 3, 2025 (CN) 202511808521.4

(51) Int. Cl. H04L 1/08; H04L 1/1607

(52) U.S. Cl. CPC H04L 1/08; H04L 1/1621

(57) ABSTRACT

A group-based low-overhead retransmission system for a lossy RDMA network includes a transmitter comprising an adaptive grouping module configured to adjust a logical group size based on a feedback packet, a bitmap module configured to store transmission status bitmaps of different logical groups in the feedback packet, a group header construction module configured to insert an extended protocol header into each data packet based on information about the logical group size and the local bitmap; and a receiver comprising an initialization and determination module configured to parse the extended protocol header; and a bitmap module configured to initialize a logical group tracking structure for a logical group arriving for the first time, to track data packets within the logical group, record a transmission status of the logical group, and detect continuity of the data packets.

### CROSS-REFERENCE TO RELATED APPLICATIONS

This application claims priority to Chinese Patent Application No. 202511808521.4 with a filing date of Dec. 3, 2025. The content of the aforementioned application, including any intervening amendments thereto, is incorporated herein by reference.

### TECHNICAL FIELD

The present disclosure relates to the technical field of data communication, and in particular, to a group-based low-overhead retransmission system for a lossy remote direct memory access (RDMA) network.

### BACKGROUND

RDMA is a high-performance communication technology that enables direct memory read/write operations between network endpoints, bypassing the operating system kernel. This technology offloads communication protocol operations, traditionally handled by the central processing unit (CPU) and kernel, to hardware, significantly reducing communication latency and improving network bandwidth. Deploying RDMA network interface cards (RNICs) and switches in data centers can achieve higher throughput and lower latency compared to traditional transmission control protocol/Internet protocol (TCP/IP) networks.

RDMA supports a plurality of implementation protocols, with RDMA over Converged Ethernet v2 (RoCEv2) being the most widely adopted. The RoCEv2 protocol primarily relies on the Go-Back-N (GBN) retransmission mechanism for packet loss recovery. Under the GBN mechanism, when a single data packet is lost, all subsequent unacknowledged data packets are retransmitted. This retransmission method undoubtedly causes considerable redundant data transmission, significantly reducing network transmission efficiency. To mitigate the performance degradation caused by the GBN mechanism, RoCEv2 typically relies on the Ethernet priority-based flow control (PFC) mechanism. PFC alleviates port congestion by pausing data flows of specific priorities, thereby creating an approximately lossless transmission environment. By sending pause frames to limit transmitter traffic, PFC effectively prevents buffer overflow and data packet loss. However, PFC introduces significant side effects. Firstly, pausing an entire priority queue causes head-of-line blocking, hindering the transmission of subsequent data. Secondly, the congestion spreading phenomenon means that congestion at one port may spread to a plurality of upstream nodes. In large-scale data centers, these issues are particularly pronounced. A plurality of flows share links, and congestion in any single flow may trigger PFC, leading to increased overall completion time, decreased goodput, and severely impacting the scalability and stability of the RDMA network.

To address the efficiency and reliability issues caused by GBN and PFC, researchers have proposed a lossy RDMA network architecture based on the Selective Retransmission (SR) mechanism. Under the SR mechanism, the system maintains a bitmap to record the reception status of each data packet. Each bit in the bitmap corresponds to one packet, indicating, with 0 or 1, whether the packet has successfully arrived at the receiver. When data packet loss is detected, only the lost packets are retransmitted, thus avoiding the redundant retransmission problem in the GBN mechanism. However, the SR mechanism also introduces new overhead bottlenecks. Since each RDMA connection needs to maintain a separate bitmap to track statuses of all unacknowledged packets, the bitmap size grows linearly with the number of RDMA connections. Furthermore, due to limited cache resources on the RNIC, an increase in bitmap size may occupy the storage space for queue pair context (QPC) on the RNIC (QPC is a key data structure used to describe and manage the status of each RDMA connection and is typically stored in the RNIC cache). If the bitmap size becomes too large and occupies the QPC storage space on the RNIC, the QPC needs to be obtained by accessing the host memory via peripheral component interconnect express (PCIe), significantly increasing data transmission latency. Consequently, in high-frequency data access scenarios, the RNIC has to access the host memory frequently, which undermines the low-latency advantage of RDMA.

RDMA networks relying on the PFC mechanism face issues like redundant retransmissions and congestion spreading. While the SR protocol improves packet loss processing capability, the high cache overhead and host access latency introduced by the bitmap mechanism limit connection scalability and performance. Therefore, there is a need for a high-performance RDMA transmission system that can efficiently manage the packet loss status, reduce redundant overhead, and support large-scale concurrent connections with limited RNIC resources, thereby optimizing RDMA communication capabilities in lossy network environments.

### SUMMARY OF PRESENT INVENTION

The objective of the present disclosure is to propose a group-based low-overhead retransmission system for a lossy RDMA network, which can efficiently manage the packet loss status, reduce redundant overhead, and support high-performance RDMA transmission for large-scale concurrent connections under limited RNIC resources. The system uses an RNIC as an execution unit and includes: a transmitter and a receiver; the transmitter includes: an adaptive grouping module, a group header construction module, a retransmission module, and a bitmap module; and the receiver includes: an initialization and determination module, a packet loss processing module, and a bitmap module;

at the transmitter, the adaptive grouping module dynamically adjusts a logical group size based on a feedback packet sent by the packet loss processing module; the bitmap module at the transmitter updates a local bitmap based on the feedback packet sent by the packet loss processing module, and stores transmission status bitmaps organized by logical groups; and the group header construction module inserts an extended protocol header into each data packet based on the logical group size and the local bitmap; and

at the receiver, the initialization and determination module parses the extended protocol header; if a logical group to which a received data packet belongs is a logical group arriving for the first time, the bitmap module initializes a logical group tracking structure for the logical group arriving for the first time, to track data packets within the logical group; or if a logical group to which a received data packet belongs is not a logical group arriving for the first time, a logical group tracking structure of the logical group to which the received data packet belongs detects continuity of data packets based on intra-group sequence numbers; if the intra-group sequence numbers are discontinuous, the packet loss processing module generates the feedback packet and sends the feedback packet back to the transmitter via the RNIC; and the retransmission module retransmits a lost data packet based on the feedback packet.

Further, the feedback packet generated by the packet loss processing module includes a pseudo-group acknowledgment (GACK) and a pseudo-group negative acknowledgment (GNAK); the pseudo-GACK is used to acknowledge a currently received consecutive data segment, and carries a group number and a length of the received consecutive data; and the pseudo-GNAK is used to indicate a currently lost packet segment, and carries a group number and missing range information.

Further, a RoCEv2 protocol is adopted for data packet transmission, and a data packet header includes: an Ethernet header, an Internet protocol (IP) header, a user datagram protocol (UDP) header, and an extended RoCEv2 header; the extended RoCEv2 header is an extension of an original base transport header (BTH) structure of RoCEv2, adding a group header and an extension header; the group header includes a 2-byte group identifier (ID), a 1-byte group size, and a 1-byte intra-group sequence number; and the extension header includes a 4-byte pseudo-GACK and a 4-byte pseudo-GNAK.

Further, the data packets within the logical group are consecutive data packets.

Further, the adaptive grouping module dynamically adjusts the logical group size based on the feedback packet sent by the packet loss processing module, expressed as:

$${δ}_{1} = {G}_{k + 1} \cdot ( {L}_{new} \cdot {S}_{k + 1} )$$

$${L}_{k + 1} = {A}_{k} \frac{{N}_{k}}{{P}_{k}} \cdot {G}_{k}$$

$${L}_{k + 1}^{′} = \frac{{N}_{k + 1}}{{P}_{k + 1}} \cdot {G}_{k}$$

$${A}_{k + 1} \frac{{N}_{k}}{{P}_{k}} {G}_{k} = α \cdot {L}_{k + 1}^{′} + ( 1 - α ) {L}_{k + 1}$$

$${A}_{k + 1} = α \cdot \frac{{N}_{k + 1} {P}_{k}}{{P}_{k + 1} {N}_{k}} + ( 1 - α ) {A}_{k}$$

$${L}_{new} = {A}_{k + 1} \frac{{N}_{k + 1}}{{P}_{k + 1}} \cdot {G}_{k}$$

$${s}_{k + 1} = \frac{{R}_{k + 1} \cdot {RTT}_{k + 1}}{{G}_{k + 1} \cdot MTU}$$

initializing δ₂ to 0, and executing a following loop when x ranges from 1 to γₖ₊₁:

$$prob\_success = {( 1 - {L}_{new} )}^{x - 1}$$

$$prob\_loss \_at \_x = {L}_{new}$$

$$remaining = {γ}_{k + 1} - x$$

$$delta2\_term += prob\_success \times prob\_loss \_at \_x \times remaining$$

ending the loop;
updating δ₂ to δ₂=Gₖ₊₁×delta2_term, and determining a value of Gₖ₊₁ that minimizes δ₁+δ₂, where
δ₁ represents a number of redundant retransmitted packets, δ₂ represents an expected retransmission data volume due to bitmap overflow, Gₖ₊₁ represents a logical group size for a (k+1)^{th} round, Lₖ₊₁ represents a predicted packet loss rate for the (k+1)^{th} round, obtained based on a prediction coefficient Aₖ, L′ₖ represents an actual packet loss rate under a group size Gₖ in a k^{th} round, Sₖ₊₁ represents a number of logical groups in the (k+1)^{th} round, Aₖ represents a prediction coefficient for the k^{th} round, Nₖ represents a number of lost logical groups in a first transmission using Gₖ as the logical group size, Pₖ represents a number of data packets in the first transmission using Gₖ as the logical group size, Gₖ represents a logical group size in the k^{th} round, L_{new} represents a predicted packet loss rate for the (k+1)^{th} round, obtained based on a prediction coefficient Aₖ₊₁, Aₖ₊₁ represents a prediction coefficient for the (k+1)^{th} round, Nₖ₊₁ represents a number of lost logical groups in a second transmission using Gₖ as the logical group size, Pₖ₊₁ represents a number of data packets in the second transmission using Gₖ as the logical group size, Rₖ₊₁ represents a network transmission rate during the second transmission using Gₖ as the logical group size, RTTₖ₊₁ represents a round-trip time (RTT) during the second transmission using Gₖ as the logical group size, MTU represents a maximum transmission unit, γₖ₊₁ represents a maximum number of logical groups supported by a bitmap in the (k+1)^{th} round, α represents a smoothing factor, prob_success represents a probability that first x−1 logical groups are successfully transmitted, prob_loss_at_x represents a probability that an x^{th} logical group is lost, remaining represents a number of additional logical groups requiring retransmission when the x^{th} logical group causes bitmap overflow, and delta2_term represents an intermediate variable.

The present disclosure further provides a group-based low-overhead retransmission method for a lossy RDMA network, implemented based on the above system. The system uses an RNIC as an execution unit and includes: a transmitter and a receiver; the transmitter includes: an adaptive grouping module, a group header construction module, a retransmission module, and a bitmap module; and the receiver includes: an initialization and determination module, a packet loss processing module, and a bitmap module;
at the transmitter, the adaptive grouping module dynamically adjusts a logical group size based on a feedback packet sent by the packet loss processing module; the bitmap module at the transmitter updates a local bitmap based on the feedback packet sent by the packet loss processing module, and stores transmission status bitmaps organized by logical groups; and the group header construction module inserts an extended protocol header into each data packet based on the logical group size and the local bitmap; and
at the receiver, the initialization and determination module parses the extended protocol header; if a logical group to which a received data packet belongs is a logical group arriving for the first time, the bitmap module initializes a logical group tracking structure for the logical group arriving for the first time, to track data packets within the logical group; or if a logical group to which a received data packet belongs is not a logical group arriving for the first time, a logical group tracking structure of the logical group to which the received data packet belongs detects continuity of data packets based on intra-group sequence numbers; if the intra-group sequence numbers are discontinuous, the packet loss processing module generates the feedback packet and sends the feedback packet back to the transmitter via the RNIC; the retransmission module retransmits a lost data packet based on the feedback packet; and the bitmap module is updated when all the data packets in the logical group tracking structure arrive.

The present disclosure further provides a computer-readable storage medium, storing a computer program. When executed by a processor, the computer program implements the group-based low-overhead retransmission method for a lossy RDMA network.

The present disclosure further provides an electronic device, including a processor and a memory. The processor and the memory are connected to each other, the memory is configured to store a computer program that includes a computer-readable instruction, and the processor is configured to invoke the computer-readable instruction to execute the group-based low-overhead retransmission method for a lossy RDMA network.

The present disclosure further provides a computer program product, including a computer program/instruction. When executed by a processor, the computer program/instruction implements steps of the group-based low-overhead retransmission method for a lossy RDMA network.

The technical solutions provided by the present disclosure have the following beneficial effects:

The present disclosure proposes a logical group transmission and retransmission system. Consecutive data packets are grouped into logical groups, and a bitmap is used to record whether each logical group accurately arrives, and the logical group size is dynamically adjusted in real-time, significantly reducing the storage space required for bitmaps. This grouping is logical grouping in nature, while the data packets remain independent physically. By introducing metadata such as a group ID, a group size, and intra-group sequence numbers into the protocol header, the transmitter and receiver can process these data packets as a logical group at the protocol semantic level. The system designs lightweight processing modules for both the transmitter and receiver on the RNIC. When packet loss occurs, the feedback packet generated by the receiver is sent back to the transmitter through the extended protocol header. The transmitter retransmits only the lost data packet without resending the entire logical group, thereby avoiding unnecessary network burden. The present disclosure can efficiently manage the packet loss status, reduce redundant overhead, and support high-performance RDMA transmission for large-scale concurrent connections with limited RNIC resources, thereby achieving breakthroughs and optimizations for RDMA communication capabilities in lossy network environments.

### BRIEF DESCRIPTION OF THE DRAWINGS

FIG. 1 is a block diagram of a group-based low-overhead retransmission system for a lossy RDMA network according to an embodiment of the present disclosure;

FIG. 2 shows a header structure of a data packet according to an embodiment of the present disclosure;

FIG. 3 shows average flow completion time (FCT) and goodput of a system (group-level bitmap) according to an embodiment of the present disclosure compared with an improved ROCE NIC (IRN) (32-bit bitmap), an IRN (1024-bit bitmap), and GBN, under different message sizes;

FIG. 4 shows average FCT and goodput of a system (group-level bitmap) according to an embodiment of the present disclosure compared with IRN (32-bit bitmap), IRN (1024-bit bitmap), and GBN, under different packet loss rates; and

FIG. 5 is a block diagram of an electronic device according to an exemplary embodiment of the present disclosure.

### DETAILED DESCRIPTION OF THE EMBODIMENTS

In order to make the objective, technical solution and advantages of the present disclosure clearer, embodiments of the present disclosure will be further described in detail in conjunction with the accompanying drawings.

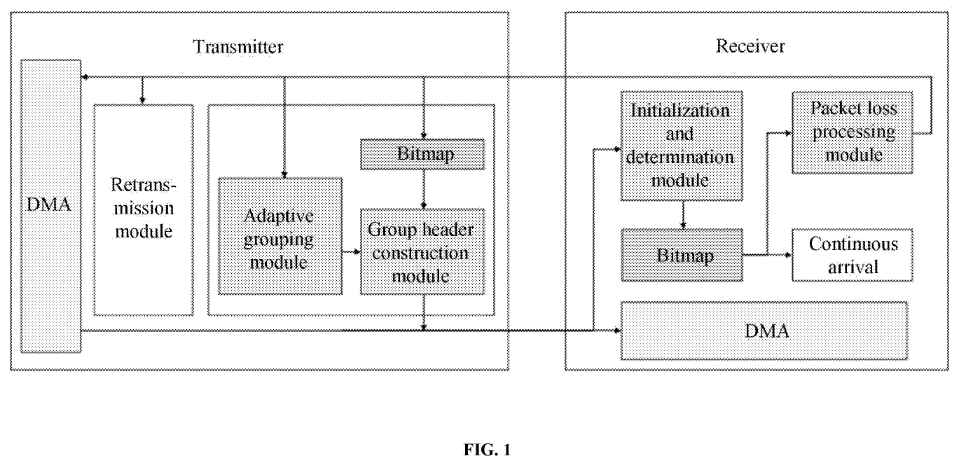

FIG. 1 is a block diagram of a group-based low-overhead retransmission system for a lossy RDMA network according to an embodiment of the present disclosure, including: a transmitter and a receiver. The transmitter includes: an adaptive grouping module, a group header construction module, a retransmission module, and a bitmap module. The receiver includes: an initialization and determination module, a packet loss processing module, and a bitmap module; In the system, data transmission is executed by using an RNIC as the core execution unit, leveraging zero-copy and low-latency characteristics of the RNIC to achieve high-performance data communication.

In traditional designs, data packet-level bitmap recording methods consume substantial storage resources as throughput increases, imposing pressure on hardware implementation. To address this issue, the present disclosure effectively mitigates the limited storage space in RNICs by introducing a coarse-grained logical group abstraction. A plurality of consecutive data packets are aggregated into a logical group, and the transmission status is recorded on a group basis, thereby compressing the fine-grained packet-level bitmap into a coarse-grained group-level bitmap. For example, eight consecutive data packets are divided into two logical transmission groups, reducing bitmap entries from eight to two. Although retransmission operations are still conducted at the data packet level, compressing only the granularity of bitmap representation significantly reduces the storage overhead for status recording. This approach alleviates the on-chip storage pressure of RNICs and enhances the feasibility and scalability of the system in high-throughput environments.

At the transmitter, upon receiving a transmission request instruction from an upper-layer application, the RNIC first actively initiates a host memory read operation through an internal DMA engine, directly transferring to-be-transmitted data into an internal transmission buffer of the RNIC. This eliminates the overhead of frequent data copies between the traditional kernel space and user space. Subsequently, the adaptive grouping module dynamically adjusts a logical group division strategy based on a feedback packet sent by the packet loss processing module and determines a logical group size to be used for the current transmission. The bitmap module at the transmitter updates a local bitmap according to the feedback packet sent by the packet loss processing module, saves transmission status bitmaps organized by logical groups, and records transmission and acknowledgment statuses of data packets in each logical group. The logical group size and the local bitmap is simultaneously transmitted to the group header construction module. After receiving an ID of a current logical group (Group ID), the group size, and intra-group packet sequence numbers, and based on the local bitmap (transmission statuses organized by logical groups), the group header construction module inserts an extended protocol header into each data packet. The extended protocol header includes metadata such as the group number, the intra-group sequence numbers, and the group size, ensuring the receiver can accurately identify the intra-group structure. The encapsulated data packet is then sent frame-by-frame to a network via a media access control (MAC) layer. During transmission, the RNIC continuously monitors acknowledgment feedback packets from the receiver and updates the local bitmap and logical group status based on the feedback content.

At the receiver, after the RNIC receives the data packet, the DMA engine writes a data portion into a local receive buffer. Simultaneously, the initialization and determination module parses the extended protocol header to extract key information such as the group number, group size, and intra-group sequence numbers. If a logical group to which the received data packet belongs is a logical group arriving for the first time, a logical group tracking structure corresponding to the logical group is immediately initialized. The bitmap module initializes the logical group tracking structure for the logical group arriving for the first time, to track data packets within the logical group. If a logical group to which the received data packet belongs is not a logical group arriving for the first time, a logical group tracking structure of the logical group to which the received data packet belongs detects continuity of data packets based on intra-group sequence numbers. If the intra-group sequence numbers are discontinuous, indicating a packet loss event, the packet loss processing module generates the feedback packet and sends the feedback packet back to the transmitter via the RNIC; and the retransmission module retransmits a lost data packet based on the feedback packet.

The feedback packet generated by the packet loss processing module includes a pseudo-GACK and a pseudo-GNAK. The pseudo-GACK is used to acknowledge a currently received consecutive data segment, and carries a group number and a length of the received consecutive data segment. The pseudo-GNAK is used to indicate a currently lost packet segment, and carries a group number and missing range information. Both types of feedback information are encapsulated in the extended protocol header and sent back to the transmitter through the RNIC. After the transmitter receives the feedback packet, the adaptive grouping module parses the feedback packet to update subsequent logical group size settings. The bitmap module at the transmitter updates the local bitmap based on the feedback packet sent by the packet loss processing module. Simultaneously, the feedback information is also passed to the retransmission module, to precisely trigger required data packet retransmission based on a missing location provided in the pseudo-GNAK, thereby minimizing redundant retransmissions and improving effective bandwidth utilization of the system in high packet loss environments.

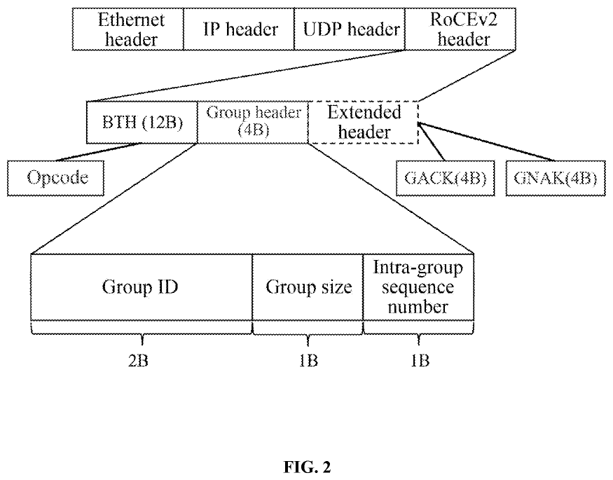

In an embodiment of the present disclosure, a RoCEv2 protocol is adopted for data packet transmission. A data packet header includes: an Ethernet header, an IP header, a UDP header, and an extended RoCEv2 header. A header structure of the data packet in this embodiment of the present disclosure is illustrated in FIG. 2. The extended RoCEv2 header extends an original 12-byte BTH structure of RoCEv2 by adding a group header and an extension header. The group header includes a 2-byte group ID, a 1-byte group size, and a 1-byte intra-group sequence number. The group header is used to identify logical group information, thereby categorizing a plurality of consecutive data packets into a same logical group at the protocol semantic level. The extension header includes a 4-byte pseudo-GACK and a 4-byte pseudo-GNAK, representing an acknowledgment or negative acknowledgment for a logical group, respectively. By reusing fields (such as the group ID) in the group header, this structure achieves a group-level reliability control mechanism while maintaining a lightweight design. This design does not require physical aggregation of data packets. Instead, through fine-grained header extensions at the protocol layer, it enables the identification, tracking, and feedback of logical groups, significantly reducing the control overhead associated with traditional tracking mechanisms based on the packet sequence numbers.

Adaptive grouping module: Since the group size determines the overall transmission efficiency of the system, an excessively large group may lead to redundant retransmissions, reducing goodput, while an overly small group may cause bitmap overflow, forcing the entire retransmission system to fall back to GBN and resulting in more severe performance degradation. The adaptive grouping module dynamically adjusts the group size based on packet loss information.

The bitmap module at the transmitter is used to store the transmission status bitmaps organized by logical groups, recording the transmission and acknowledgment statuses of data packets within each logical group.

The group header construction module is primarily responsible for encapsulating logical group metadata of a to-be-transmitted data packet at the protocol stack layer. By extending the RoCEv2 protocol stack, this module inserts a 4-byte group header into each data packet, to describe the logical group ID, the logical group size, and the intra-group sequence numbers. This method avoids significant modifications to the RNIC protocol stack, ensures compatibility with the existing RoCEv2 protocol, and enables protocol extension without altering the fundamental transmission semantics. Logically, the module appends a 4-byte group header to each data packet and completes group information insertion, sequence number management, and structure organization within the protocol stack. Compared to traditional mechanisms that rely on independent acknowledgments for each data packet, the group-based acknowledgment strategy constructs group-level acknowledgments (pseudo-GACK) and negative acknowledgments (pseudo-GNAK). This allows the receiver to provide feedback on the status of an entire logical group at once, thereby reducing the number of control messages and processing overhead. Particularly in high-bandwidth, high-latency network scenarios, traditional mechanisms require maintaining the statuses of a large number of unacknowledged packets with an overhead of O(N), whereas this mechanism reduces the overhead to O(N/K) through logical aggregation. K is the average group size.

The bitmap module at the receiver records the transmission status of each logical group. Upon detecting discontinuous intra-group sequence numbers, indicating data packet loss, it triggers the packet loss processing module to enter exception processing.

Packet loss processing module: For the received consecutive data segment, the receiver constructs a pseudo-GACK to notify the transmitter that this portion of data has been fully received. Concurrently, this segment is “marked as complete,” specifically by adding a special identifier, 0xFFFF, to the group header, indicating that this pseudo-group has been completed. For a lost data segment, the receiver generates a pseudo-GNAK to inform the transmitter that the data segment needs retransmission. Although the original group ID is used, the field of the group size is modified to include only the missing portion. The two feedback packets (for the received segment and the lost segment) are sent back to the transmitter as feedback via the extended protocol header. Upon receipt, the transmitter can retransmit only the lost data packet without resending the entire logical group, thus avoiding unnecessary network burden. This “intra-group segmentation” method enhances retransmission precision. Furthermore, it requires no additional control packets, achieving this functionality through the clever reuse of protocol header fields based on the original RoCEv2 structure with only lightweight extensions.

The adaptive grouping module dynamically adjusts the logical group size based on the feedback packets sent by the packet loss processing module, which can be expressed by the following formulas:

$${δ}_{1} = {G}_{k + 1} \cdot ( {L}_{new} \cdot {S}_{k + 1} )$$

$${L}_{k + 1} = {A}_{k} \frac{{N}_{k}}{{P}_{k}} \cdot {G}_{k}$$

$${L}_{k + 1}^{′} = \frac{{N}_{k + 1}}{{P}_{k + 1}} \cdot {G}_{k}$$

$${A}_{k + 1} \frac{{N}_{k}}{{P}_{k}} {G}_{k} = α \cdot {L}_{k + 1}^{′} + ( 1 - α ) {L}_{k + 1}$$

$${A}_{k + 1} = α \cdot \frac{{N}_{k + 1} {P}_{k}}{{P}_{k + 1} {N}_{k}} + ( 1 - α ) {A}_{k}$$

$${L}_{new} = {A}_{k + 1} \frac{{N}_{k + 1}}{{P}_{k + 1}} \cdot {G}_{k}$$

$${s}_{k + 1} = \frac{{R}_{k + 1} \cdot {RTT}_{k + 1}}{{G}_{k + 1} \cdot MTU}$$

δ₂ is initialized to 0, and a following loop is executed when x ranges from 1 to γₖ₊₁:

$$prob\_success = {( 1 - {L}_{new} )}^{x - 1}$$

$$prob\_loss \_at \_x = {L}_{new}$$

$$remaining = {γ}_{k + 1} - x$$

$$delta2\_term += prob\_success \times prob\_loss \_at \_x \times remaining$$

The loop ends.

δ₂ is updated to δ₂=Gₖ₊₁×delta2_term, and a value of Gₖ₊₁ that minimizes δ₁+δ₂ is determined.

δ₁ represents a number of redundant retransmitted packets, δ₂ represents an expected retransmission data volume due to bitmap overflow, Gₖ₊₁ represents a logical group size for a (k+1)^{th} round, Lₖ₊₁ represents a predicted packet loss rate for the (k+1)^{th} round, obtained based on a prediction coefficient Aₖ, L′ₖ represents an actual packet loss rate under a group size Gₖ in a k^{th} round, Sₖ₊₁ represents a number of logical groups in the (k+1)^{th} round, Aₖ represents a prediction coefficient for the k^{th} round, Nₖ represents a number of lost logical groups in a first transmission using Gₖ as the logical group size, Pₖ represents a number of data packets in the first transmission using Gₖ as the logical group size, Gₖ represents a logical group size in the k^{th} round, L_{new} represents a predicted packet loss rate for the (k+1)^{th} round, obtained based on a prediction coefficient Aₖ₊₁, Aₖ₊₁ represents a prediction coefficient for the (k+1)^{th} round, Nₖ₊₁ represents a number of lost logical groups in a second transmission using Gₖ as the logical group size, Pₖ₊₁ represents a number of data packets in the second transmission using Gₖ as the logical group size, Rₖ₊₁ represents a network transmission rate during the second transmission using Gₖ as the logical group size, RTTₖ₊₁ represents an RTT during the second transmission using Gₖ as the logical group size, MTU represents a maximum transmission unit, γₖ₊₁ represents a maximum number of logical groups supported by a bitmap in the (k+1)^{th} round, α represents a smoothing factor, prob_success represents a probability that first x−1 logical groups are successfully transmitted, prob_loss_at_x represents a probability that an x^{th} logical group is lost, remaining represents a number of additional logical groups requiring retransmission when the x^{th} logical group causes bitmap overflow, and delta2_term represents an intermediate variable.

In an exemplary embodiment, a group-based low-overhead retransmission method for a lossy RDMA network is provided. The method is implemented based on the above system. The system uses an RNIC as an execution unit and includes: a transmitter and a receiver. The transmitter includes: an adaptive grouping module, a group header construction module, a retransmission module, and a bitmap module. The receiver includes: an initialization and determination module, a packet loss processing module, and a bitmap module.

At the transmitter, the adaptive grouping module dynamically adjusts a logical group size based on a feedback packet sent by the packet loss processing module. The bitmap module at the transmitter updates a local bitmap based on the feedback packet sent by the packet loss processing module, and stores transmission status bitmaps organized by logical groups. The group header construction module inserts an extended protocol header into each data packet based on the logical group size and the local bitmap.

At the receiver, the initialization and determination module parses the extended protocol header. If a logical group to which a received data packet belongs is a logical group arriving for the first time, the bitmap module initializes a logical group tracking structure for the logical group arriving for the first time, to track data packets within the logical group; or if a logical group to which a received data packet belongs is not a logical group arriving for the first time, a logical group tracking structure of the logical group to which the received data packet belongs detects continuity of data packets based on intra-group sequence numbers. If the intra-group sequence numbers are discontinuous, the packet loss processing module generates the feedback packet and sends the feedback packet back to the transmitter via the RNIC. The retransmission module retransmits a lost data packet based on the feedback packet. The bitmap module is updated when all the data packets in the logical group tracking structure arrive.

The performance of the present disclosure is evaluated, focusing primarily on two metrics: average FCT and goodput, which effectively reflect network transmission performance and are closely related to the retransmission method. Experiments were conducted using a field programmable gate array (FPGA) simulator built with the Vitis High-Level Synthesis (VITIS_HLS) tool. A simulation platform includes a transmitter, a receiver, and a network. The present disclosure uses HLS to implement a switch with random packet loss capability to simulate the network environment. The evaluation compares the group-level bitmap method with IRN (a RoCE-based network protocol) and GBN in terms of average FCT and goodput under different message sizes and packet loss rates. IRN is a widely used solution in lossy RDMA networks. In the evaluation, IRN was implemented in two forms: IRN with a 1024-bit bitmap and IRN with a 32-bit bitmap. The only difference is the bitmap overhead, while the rest of the transmission control logic remains unchanged. IRN (1024 bits) demonstrates the performance achievable when the RNIC state overhead is ignored, while IRN (32 bits) limits the bitmap size to 32 bits, which is comparable to the size of the group-level bitmap.

Parameters such as the data packet size and network settings were configured in the present disclosure to ensure a fair evaluation across different methods. The data payload per data packet was set to 1024 bytes. Dedicated priority queues were enabled on the switch for transmitting retransmission signals and feedback control messages, to prevent packet loss from triggering retransmissions based on timeouts, which could introduce additional uncertainties in the experimental results. The base data transmission amount was set to 1 MB, and the RTT was 12.8 microseconds.

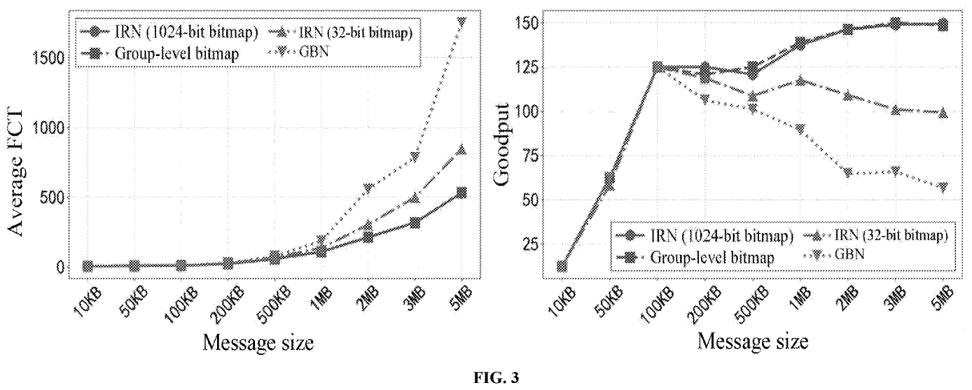

FIG. 3 shows average FCT and goodput of a system (group-level bitmap) according to an embodiment of the present disclosure compared with IRN (32-bit bitmap), IRN (1024-bit bitmap), and GBN, under different message sizes. As the message size increases from 10 KB to 5 MB, the average FCT for all transmission mechanisms increases significantly. When the message size exceeds 100 KB, the transmission process spans a plurality of RTTs. The larger the message, the longer the overall transmission latency. Particularly, when the bitmap is compressed to 32 bits, the average FCT for IRN (32-bit bitmap) increases significantly. When the message size reaches 5 MB, its average FCT is about 59.5% higher compared to the IRN using the large bitmap (1024-bit bitmap). In contrast, even with the same 32-bit bitmap, the group-level bitmap of the present disclosure shows only a 0.3% increase in average FCT, demonstrating better robustness. For a 5 MB message size, the FCT increase is 13.1%.

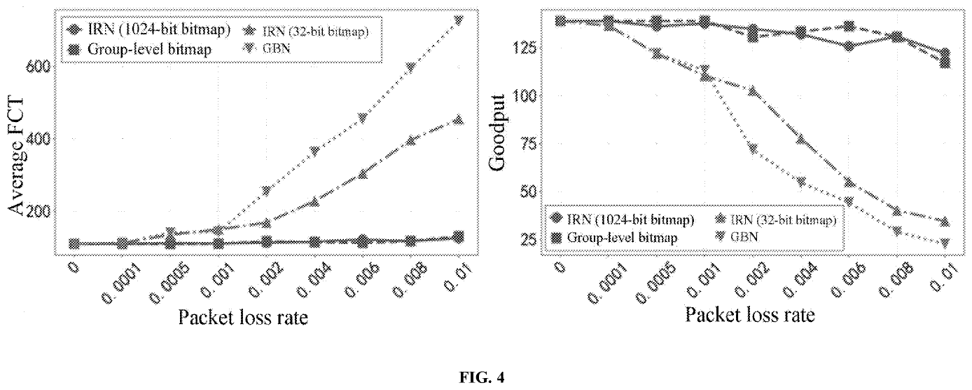

FIG. 4 shows the average FCT and goodput of a system (group-level bitmap) according to an embodiment of the present disclosure compared with IRN (32-bit bitmap), IRN (1024-bit bitmap), and GBN, under different packet loss rates, demonstrating the impact of different packet loss rates on the performance of each scheme. The left graph demonstrates the average FCT as the packet loss rate increases. Both the GBN and IRN (32-bit bitmap) experience a sharp deterioration in FCT as the packet loss rate rises, while the group-level bitmap and IRN (1024-bit bitmap) remain stable under various packet loss conditions, indicating stronger robustness and more effective retransmission strategy. The right graph demonstrates the goodput performance under the same packet loss condition. The GBN and IRN (32-bit bitmap) show a significant decline in goodput, while the group-level bitmap and IRN (1024-bit bitmap) maintain goodput close to full speed, further verifying the superior performance in high packet loss environments.

In an exemplary embodiment, a computer-readable storage medium is provided, storing a computer program. When executed by a processor, the computer program implements the group-based low-overhead retransmission method for a lossy RDMA network.

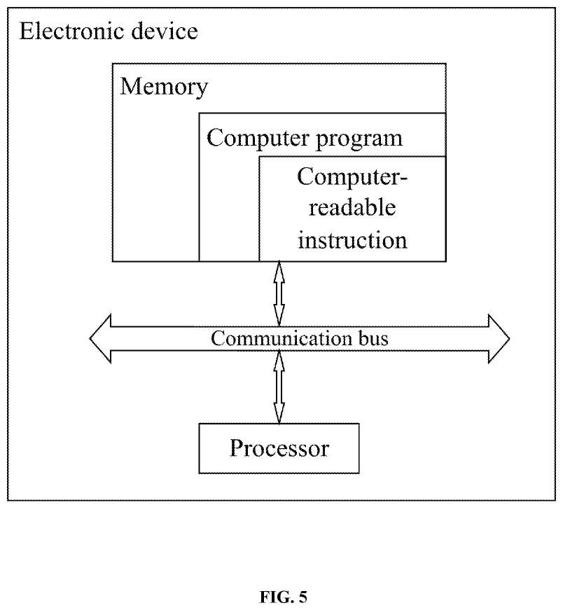

Referring to FIG. 5, in an exemplary embodiment, an electronic device is further provided, including at least one processor, at least one memory, and at least one communication bus.

The memory stores a computer program, the computer program includes a computer-readable instruction, and the processor invokes, through a communication bus, the computer-readable instruction stored in the memory, to execute the group-based low-overhead retransmission method for a lossy RDMA network.

In an exemplary embodiment, a computer program product is provided, including a computer program/instruction. When executed by a processor, the computer program/instruction implements steps of the group-based low-overhead retransmission method for a lossy RDMA network.

The above description of the disclosed embodiments enables those skilled in the art to achieve or use the present disclosure. Various modifications to these embodiments are readily apparent to those skilled in the art, and the generic principles defined herein may be practiced in other embodiments without departing from the spirit or scope of the present disclosure. Thus, the present disclosure is not limited to the examples shown herein but falls within the widest scope consistent with the principles and novel features disclosed herein.

What is claimed is:

1. A group-based low-overhead retransmission system for a lossy remote direct memory access (RDMA) network, wherein the system uses an RDMA network interface card (RNIC) as an execution unit and comprises: a transmitter and a receiver; the transmitter comprises: an adaptive grouping module, a group header construction module, a retransmission module, and a bitmap module; and the receiver comprises: an initialization and determination module, a packet loss processing module, and a bitmap module;
in the transmitter, the adaptive grouping module dynamically adjusts a logical group size based on a feedback packet sent by the packet loss processing module; the bitmap module updates a local bitmap based on the feedback packet sent by the packet loss processing module, and stores transmission status bitmaps organized by logical groups; and the group header construction module inserts an extended protocol header into each data packet based on the logical group size and the local bitmap; and
in the receiver, the initialization and determination module parses the extended protocol header; when a logical group to which a received data packet belongs is a logical group arriving for a first time, the bitmap module initializes a logical group tracking structure for the logical group arriving for the first time, to track data packets within the logical group; alternatively when a logical group to which a received data packet belongs is not a logical group arriving for the first time, a logical group tracking structure of the logical group to which the received data packet belongs detects continuity of data packets based on intra-group sequence numbers; when the intra-group sequence numbers are discontinuous, the packet loss processing module generates the feedback packet and sends the feedback packet back to the transmitter via the RNIC; the retransmission module retransmits a lost data packet based on the feedback packet; and the bitmap module is updated when all the data packets in the logical group tracking structure arrive;
wherein the adaptive grouping module dynamically adjusts the logical group size based on the feedback packet sent by the packet loss processing module, expressed as:
$${δ}_{1} = {G}_{k + 1} \cdot ( {L}_{new} \cdot {S}_{k + 1} )$$
$${L}_{k + 1} = {A}_{k} \frac{{N}_{k}}{{P}_{k}} \cdot {G}_{k}$$
$${L}_{k + 1}^{′} = \frac{{N}_{k + 1}}{{P}_{k + 1}} \cdot {G}_{k}$$
$${A}_{k + 1} \frac{{N}_{k}}{{P}_{k}} {G}_{k} = α \cdot {L}_{k + 1}^{′} + ( 1 - α ) {L}_{k + 1}$$
$${A}_{k + 1} = α \cdot \frac{{N}_{k + 1} {P}_{k}}{{P}_{k + 1} {N}_{k}} + ( 1 - α ) {A}_{k}$$
$${L}_{new} = {A}_{k + 1} \frac{{N}_{k + 1}}{{P}_{k + 1}} \cdot {G}_{k}$$
$${s}_{k + 1} = \frac{{R}_{k + 1} \cdot {RTT}_{k + 1}}{{G}_{k + 1} \cdot MTU}$$
initializing δ₂ to 0, and executing a following loop when x ranges from 1 to γₖ₊₁:
$$prob\_success = {( 1 - {L}_{new} )}^{x - 1}$$
$$prob\_loss \_at \_x = {L}_{new}$$
$$remaining = {γ}_{k + 1} - x$$
$$delta2\_term += prob\_success \times prob\_loss \_at \_x \times remaining$$
ending the loop;
updating δ₂ to δ₂=Gₖ₊₁×delta2_term, and determining a value of Gₖ₊₁ that minimizes δ₁+δ₂, wherein
δ₁ represents a number of redundant retransmitted packets, δ₂ represents an expected retransmission data volume due to bitmap overflow, Gₖ₊₁ represents a logical group size for a (k+1)^{th} round, Lₖ₊₁ represents a predicted packet loss rate for the (k+1)^{th} round, obtained based on a prediction coefficient Aₖ, L′ₖ represents an actual packet loss rate under a group size Gₖ in a k^{th} round, Sₖ₊₁ represents a number of logical groups in the (k+1)^{th} round, Aₖ represents a prediction coefficient for the k^{th} round, Nₖ represents a number of lost logical groups in a first transmission using Gₖ as the logical group size, Pₖ represents a number of data packets in the first transmission using Gₖ as the logical group size, Gₖ represents a logical group size in the k^{th} round, L_{new} represents a predicted packet loss rate for the (k+1)^{th} round, obtained based on a prediction coefficient Aₖ₊₁, Aₖ₊₁ represents a prediction coefficient for the (k+1)^{th} round, Nₖ₊₁ represents a number of lost logical groups in a second transmission using Gₖ as the logical group size, Pₖ₊₁ represents a number of data packets in the second transmission using Gₖ as the logical group size, Rₖ₊₁ represents a network transmission rate during the second transmission using Gₖ as the logical group size, RTTₖ₊₁ represents a round-trip time (RTT) during the second transmission using Gₖ as the logical group size, MTU represents a maximum transmission unit, γₖ₊₁ represents a maximum number of logical groups supported by a bitmap in the (k+1)^{th} round, α represents a smoothing factor, prob_success represents a probability that first x−1 logical groups are successfully transmitted, prob_loss_at_x represents a probability that an x^{th} logical group is lost, remaining represents a number of additional logical groups requiring retransmission when the x^{th} logical group causes bitmap overflow, and delta2_term represents an intermediate variable.

2. The group-based low-overhead retransmission system according to claim 1, wherein the feedback packet generated by the packet loss processing module comprises a pseudo-group acknowledgment (GACK) and a pseudo-group negative acknowledgment (GNAK); the pseudo-GACK is used to acknowledge a currently received consecutive data segment, and carries a group number and a length of the received consecutive data segment; and the pseudo-GNAK is used to indicate a currently lost packet segment, and carries a group number and missing range information.

3. The group-based low-overhead retransmission system according to claim 2, wherein an RDMA over converged Ethernet v2 (RoCEv2) protocol is adopted for data packet transmission, and a data packet header comprises: an Ethernet header, an Internet protocol (IP) header, a user datagram protocol (UDP) header, and an extended RoCEv2 header; the extended RoCEv2 header is an extension of an original base transport header (BTH) structure of RoCEv2, adding a group header and an extension header; the group header comprises a 2-byte group identifier (ID), a 1-byte group size, and a 1-byte intra-group sequence number; and the extension header comprises a 4-byte pseudo-GACK and a 4-byte pseudo-GNAK.

4. The group-based low-overhead retransmission system according to claim 1, wherein the data packets within the logical group are consecutive data packets.
